(19) United States
(12) Patent Application Publication
(10) Pub. No.: US 2014/0081885 A1
(43) Pub. Date: Mar. 20, 2014

(54) METHOD FOR PROVIDING BENEFICIARY CONCIERGE SERVICES

(71) Applicant: Fred Thomas Maxwell, II, Pilot Point, TX (US)

(72) Inventor: Fred Thomas Maxwell, II, Pilot Point, TX (US)

(21) Appl. No.: 14/085,453

(22) Filed: Nov. 20, 2013

Related U.S. Application Data
(63) Continuation of application No. 12/433,812, filed on Apr. 30, 2009, now abandoned.
(60) Provisional application No. 61/125,999, filed on Apr. 30, 2008.

(51) Int. Cl. G06Q 10/10

(52) U.S. Cl. CPC G06Q 10/1057
USPC 705/322

(57) ABSTRACT

The current invention is for a system and method for providing “concierge” services to beneficiaries of a covered person provided immediately after death; and for providing “concierge” services to claimants of dismemberment, and continuing throughout the duration of the benefits claim process. The method for this service is offered to the employees and dependents insured through corporate sponsored group life and accident insurance programs. The method includes filing, handling and expediting insurance benefit claims and payouts; corporate sponsored retirement programs and stock benefits transfer, or “roll-over”, to an Individual Retirement Account; handling employee death related communications, paperwork and processing; and providing financial counseling.

### CROSS-REFERENCE TO RELATED APPLICATION

This application is a continuation of U.S. patent application Ser. No. 12/433,812 entitled METHOD FOR PROVIDING BENEFICIARY CONCIERGE SERVICES, filed Apr. 30, 2009, which claims the benefit of U.S. Provisional application No. 61/125,999, filed Apr. 30, 2008.

### BACKGROUND

When a person dies their beneficiary, employer, and/or insurer must all perform numerous actions. When an employee suffers dismemberment, the employer and insurer must also perform numerous actions. These actions are complex and administratively difficult to execute. Normally, it is during this time that the beneficiary or beneficiaries are often emotionally distraught and vulnerable. If that person was an insured employee or dependent, i.e., a covered person, the employer has numerous administrative burdens that are often overwhelming. Both single beneficiaries and a plurality of beneficiaries are both referred to herein with the term “beneficiary.”

At the time of the covered person's death, there is a lack of comprehensive and coordinated services available to the covered person's beneficiary, employer, and/or insurer. At best, the beneficiary and employer manage to work in an uncoordinated and unguided manner, until they have eventually fulfilled all of the legal requirements to adjudicate the claim. This time consuming effort creates the great potential for some benefits to be missed or lost due to oversight or inaction.

When a loved one dies, many people rely solely upon a funeral home director or counselor to tell them what they need to do. Unfortunately, it is at this point that people begin to make mistakes that have a potential for negative economic impact. Typically, a person contacts a funeral home to arrange for their loved one to be buried or cremated. Beyond providing a copy of the death certificate, too few funeral home directors or counselors have the knowledge to inform the beneficiary what is required to file for benefits in areas of business, insurance or government. For example, few people have experience filing a life and accident claim with an insurance company to request life and accident claim benefits. Additionally, advice on accessing any employer benefits and retirement benefits due to a beneficiary is not a service most funeral home directors or counselors have experience or knowledge to provide. Thus, the beneficiary has the potential to miss some benefits to which they are entitled.

Many beneficiaries are unaware of the benefits they are entitled to receive from a covered person's employer. The detailed workings of the employer's retirement benefits package(s) may not have been made available to the beneficiary. Additionally, gaining the knowledge of how to access or convert employer sponsored retirement benefits is often not readily available. And, if the beneficiary does not access or convert the retirement benefits properly, they may be subjected to a potentially large tax burden.

Employers are also presented with difficulties at the time of death a covered person. Depending upon the size and age of the business, the employer may never have experienced a claim by a covered person. In some situations, the employers may not have any knowledge, or have a developed plan, regarding the actions they need to take in these situations.

Insurers are often faced with the problem that notification of the death of a covered person occurs only when the beneficiary finds the policy and tries to make a claim. Often, insurance policies fail to have a current address for the beneficiary. In the event of a death, without an assignment, the insurance company is unable to pay the funeral costs to a funeral home. Additionally, there may be multiple beneficiaries trying to make an insurance claim, thus complicating the insurer's ability to process and pay a benefit.

As identified herein, the industry will benefit from a method providing comprehensive death benefits services to the employers, insurers, and beneficiaries of a covered person. As used herein, the reference to a single beneficiary is also applicable to a plurality of beneficiaries.

### SUMMARY OF THE INVENTION

In one embodiment, a method for providing beneficiary services for an employer is provided, the method comprising the steps of:

(a) identifying all employment benefits and benefit related information provided by the employer for a covered person, the benefit related information including identification of a beneficiary, an insurer, and at least one data set associating the beneficiary with the covered person;

(b) entering information on the benefits and benefit related information into a computer database;

(c) using the computer to analyze the information on the benefits and benefit related information provided by the employer;

(d) correlating the beneficiary with the covered person and the benefits;

(e) creating an event file in the database, the event file created when the covered person dies or suffers a dismemberment;

(f) said computer using said database to generate at least one beneficiary letter; and

(g) wherein said computer further generates status reports using data found in said database.

Numerous objects and advantages of the invention will become apparent as the following detailed description of the preferred embodiments is read in conjunction with the drawings which illustrate such embodiments.

### BRIEF DESCRIPTION OF THE DRAWINGS

FIG. 1 depicts a flow-chart of the method for providing services to the covered person's beneficiary.

FIG. 2 depicts a flow-chart of the method for providing services to the covered person's employer.

FIG. 3 depicts a flow-chart of the method for providing the beneficiary financial services.

FIG. 4 depicts a flow-chart of the method for providing the information exchange between the beneficiary, employer and insurer.

FIG. 5 depicts a flow-chart of the method for providing beneficiary letters.

FIG. 6 depicts a flow-chart of the method for providing Beneficiary Service Provider (BSP) online access.

FIG. 7 depicts a flow-chart of the method for dismemberment claim process.

FIG. 8 depicts a flow-chart of the method for estate settlement.

### DETAILED DESCRIPTION

This invention is for a method to provide comprehensive services to a covered person's beneficiary, employer and insurance company. Preferably, a suite of services, analogous to “concierge services,” is provided to assist the beneficiary throughout the difficult time after a covered person dies. Similar services are provided to the employee when they suffer a dismemberment. These services are also provided to the employer and insurer. The BSP services are customized for each employer.

The BSP works with the employer to identify all employment related benefits provided by the employer for the covered person. Using a computer and human oversight, the BSP analyzes the benefits for each covered person and develops a database with all the covered person's benefits and beneficiary information. Within the BSP's database, the covered person is associated with the employer, the beneficiary and the benefits. The operator is able to access and manipulate a database storing information related to the benefit coverage, identify key dates, identify financial information, store reports, checklists, forms, telephone transcriptions, electronic communications, and other similar information. If available, the database stores the beneficiary email information, and is adapted to transmit correspondence to the beneficiary. Additionally, the BSP's database stores and provides for correlation of non-employer data related to the covered person.

When notified of the death of the covered person, the BSP uses the computer and manipulates the database to identify the covered person, to correlate that person's benefits with the beneficiary, and generate the desired reports and/or letters. A case file is automatically opened and provides a checklist for the BSP to follow, as well as providing for tracking/reporting the status of actions taken by the BSP. Additionally, by manipulating the input parameters manually or automatically, the BSP is able to populate the letters to the beneficiary with pertinent benefit information. The computer is programmed to generate reports on the status of each open case file.

Using the products generated by the BSP, computer and database, the BSP is able to quickly respond to the death event. This response may be initially a verbal contact with the beneficiary that outlines the BSP's role and informs the beneficiary that they will be receiving a beneficiary package in the mail outlining the benefits due to the beneficiary. A formal response will follow the verbal contact, and will include the generation of letters that outline the benefits and have any necessary forms attached to thereto. The necessary forms are described herein, but at least include the request for life and accident claim benefits.

### Employee/Covered Person

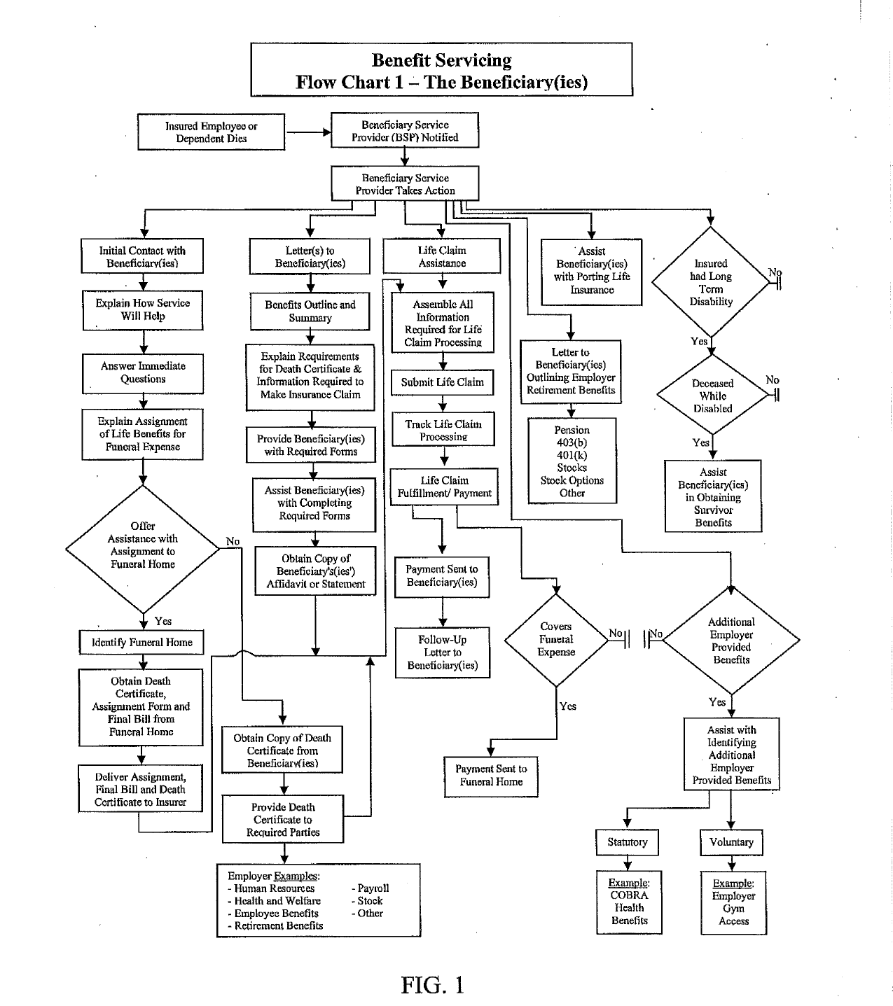

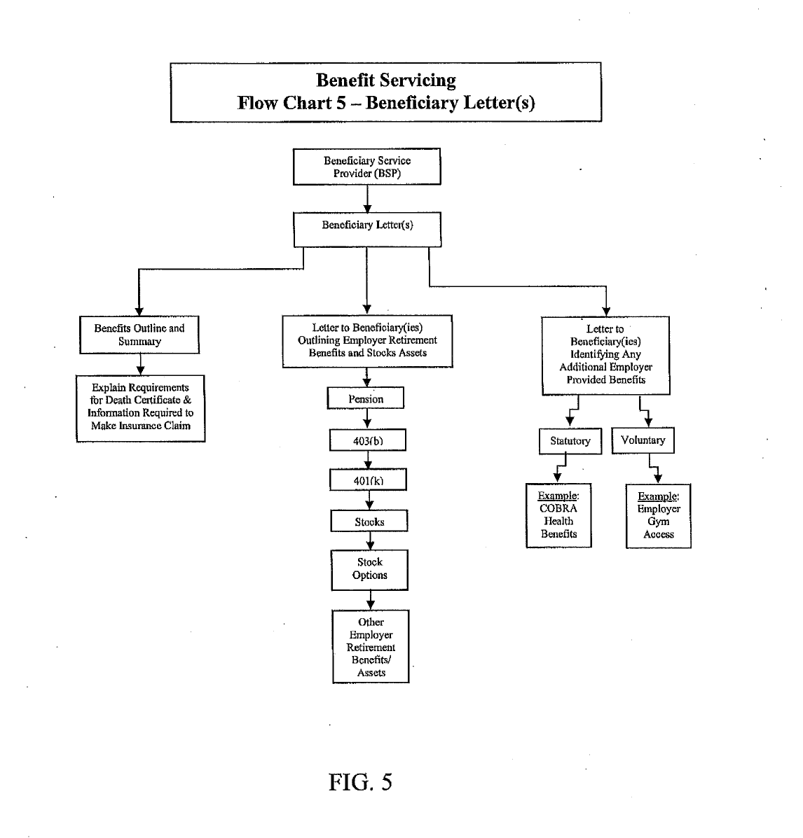

Referring to FIGS. 1 and 5, one embodiment begins with the death of a covered person and the BSP being notified of the death. The BSP then performs several different tasks. One task is to make initial contact with the beneficiary to answer any immediate questions regarding the life and accident claim process. In this initial contact, the BSP will introduce the services they provide to the beneficiary, discuss how the BSP can and will assist them through the process, and answer any immediate questions from the beneficiary. Part of the contact is for the BSP to explain the services to be provided in filing for benefits or services, and/or with filing for any employer sponsored benefits packages or other services. The BSP contact opens up a dialogue for the beneficiary to answer any questions they have regarding the employer sponsored benefits package. If there are multiple beneficiaries, the BSP will provide the same initial contact to all of the known beneficiaries.

Along with an explanation, the BSP explains the beneficiary information on the option and process to assign a portion of the life and accident claim benefits to the funeral home to cover the funeral expense. An offer is then made by the BSP to assist with assigning a portion of a life claim and accident benefits to a funeral home.

If the beneficiary wishes to assign payment directly to the funeral home from the life and accident proceeds, the BSP will contact the funeral home to obtain a copy of the death certificate, the assignment form, and the final bill from the funeral home. The BSP will deliver the completed assignment form, final bill and death certificate to the appropriate insurer.

If the beneficiary chooses not to assign payment to the funeral home, the BSP will request a copy of the death certificate from the beneficiary, and provide it to the insurance carrier and other parties as described herein. The source of the death certificate is typically the funeral home.

As depicted in FIGS. 1 and 5, another task the BSP performs is to provide the beneficiary with information regarding porting or converting their life insurance if they are covered under the plan in the letter to the beneficiary. The BSP drafts and delivers the letter to the beneficiary that outlines and summarizes all of the benefits, insurance policies and expected proceeds therefrom. At a minimum, the letter contains at least one benefit. Within the letter, the BSP also provides a discussion regarding the requirement of the death certificate and the type of information required to be on the death certificate. The discussion about the information on the death certificate ensures that the beneficiary filing for the life and accident claim benefits with the insurer does not encounter any unnecessary processing delays, and receives prompt payment. The letter also includes the required forms for filing for the life and accident claim benefits and offers to assist the beneficiary in filling out the forms. A beneficiary affidavit or statement to be completed by the beneficiary is also included with the letter for submission with the life and accident claim. A copy of the beneficiary's affidavit or statement is obtained by the BSP to be filed with the life and accident claim benefits application. If the claim is for a covered dependent, the BSP will re-solicit for a new beneficiary designation form in the letter to the employee. Upon receipt of the new beneficiary designation form, the BSP will mail the original beneficiary designation form to the employer while keeping a copy for the BSP's records.

Since numerous entities require a copy of the death certificate, the BSP expedites the delivery of a copy to those entities. As part of this method, the BSP will at least provide the death certificate to the employer's departments or points of contact for human resources, payroll, employee benefits, or retirement benefits. The BSP will also deliver the death certificate copies to other departments or points of contact within the employer's organization that may require a copy.

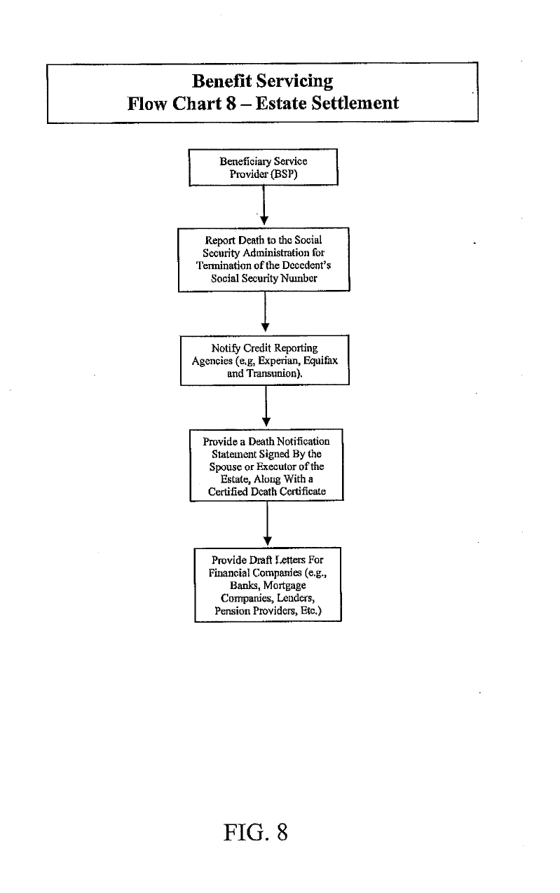

As shown in FIG. 8, the BSP also assists the beneficiary with the estate settlement process. This assistance includes providing the beneficiary a checklist outlining the actions and agencies requiring contact regarding death notification. The checklist may be in paper form and/or made available electronically. On behalf of the beneficiary, the BSP assumes responsibility for notifying the Social Security Administration of the covered person's death and works to terminate their Social Security Number. This includes the filling out of forms and all necessary filing actions. The estate settlement process also includes notifying all credit reporting agencies of the death of the covered person. This includes providing a Death Notification Statement signed by the spouse or executor of the estate, along with a certified death certificate. The BSP provides copies of all forms and status updates to the beneficiary.

Additionally, the BSP provides assistance during the life and accident claims process by completing the life and accident claims form for the employer. The BSP collects, collates and verifies all of the appropriate paperwork for filing the claim benefits, and files the claim with the insurer. This paperwork includes at least the life and accident claim form, beneficiary's affidavit or statement, completed death certificate, funeral home assignment form and the final bill. Other documentation necessary to process the claim will also be collected, collated and processed by the BSP. If the cause of death of the insured was an accident, the BSP will research to obtain news clippings and/or a police report to validate the cause of death. This non-employer data/information is electronically inserted into the database and automatically generated to be attached with all appropriate forms. The BSP then files the completed life and accident claims forms with the insurer.

Once filed, the BSP tracks the life and accident claim through the insurer's claim processing procedure until the life and accident claim benefit is fulfilled. Tracking includes obtaining data on the status of the life and accident claim, converting that data to a condensed report or status for the beneficiary, and logging the status in an accessible location. The BSP provides status to the beneficiary as necessary, and preferably makes the status available via a computer based online database server. The BSP may choose to provide both online status and paper reports to the beneficiary.

The method also provides for the BSP to assist with the beneficiary's life and accident claim fulfillment process upon claim payment. For instance, if the claim payment is to be issued to a secure banking account and the beneficiary has trouble identifying the secure bank, the BSP will provide the beneficiary with help identifying the secure bank information. If the beneficiary had elected to file an assignment of the life and accident claim benefits to the funeral home to cover the funeral expenses, the assigned part of the life and accident claim benefits payment is sent to the funeral home.

The BSP sends at least one follow-up letter to the beneficiary after the life and accident claim benefit has been fulfilled or paid. The follow-up letter identifies the benefits the beneficiary should have received, and when they should have received payment from the insurer. Additionally, the letter may solicit a customer satisfaction survey to help the BSP to improve their service.

Referring to FIGS. 1-3, an employee, who is the covered person, may receive retirement benefits from their employer as part of their compensation package. Therefore, the BSP will also develop and send a letter to the beneficiary explaining and/or outlining the employer provided retirement benefits of the covered person. This may include the employer's pension program, a 403(b) or 401(k) retirement plan, stocks, stock options, or other retirement benefits. There may be a forced distribution of many of these retirement benefits, which must be converted or transferred upon the death of the employee. The BSP advises the beneficiary in the conversion and handling of these retirement benefits, or refers the beneficiary to resources capable of properly advising them. The BSP also assists the beneficiary in receiving and managing any employer retirement benefits or stocks that are part of the covered person's estate.

Some covered persons are approved for a long term disability (LTD) claim(s). If the insured covered person died while approved for a LTD claim, there may be survivor benefits due to the beneficiary. In these instances, the beneficiary will need to make a claim to receive the survivor benefits. The BSP assists the beneficiary in applying for the survivor benefits and to expedite the claims process.

Some employer's provide insurance for the dependents of their employees, who are covered persons. When the insured employee dies, the dependent's insurance may be ported to another policy or terminated. Most beneficiaries lack any experience in porting insurance. The BSP supplies the beneficiary with the appropriate portability form(s), assists the beneficiary in filing out the portability form(s), provides instruction to the beneficiary on the process of porting their dependent life insurance, and, if requested, files the portability form(s) for the beneficiary with the proper insurance carrier.

In some cases, additional benefits are due to the beneficiary upon the death of the covered person. For example, the law may require that some health benefits continue for a period of time after the death of a covered person. Another example might be if the employer has a voluntary policy of continuing to provide benefits to the beneficiary after the death of a covered person. A non-limiting example of the voluntary benefits might be employer gymnasium access. The BSP assists the beneficiary in identifying, accessing and receiving any additional employer benefits that may continue for a period of time beyond the death of a covered person.

As shown in FIG. 1, the BSP collects, assembles and transforms the collective data related to the covered person, usually stored or filed in multiple locations/databases, into at least one document summarizing the benefits related to the covered person. The document, usually a letter is transmitted to the beneficiary. The BSP also fills out forms, or assists in the filling of forms, for the beneficiary. On behalf of the beneficiary, the BSP files the forms with the proper agencies, businesses or insurance carriers.

### Employer

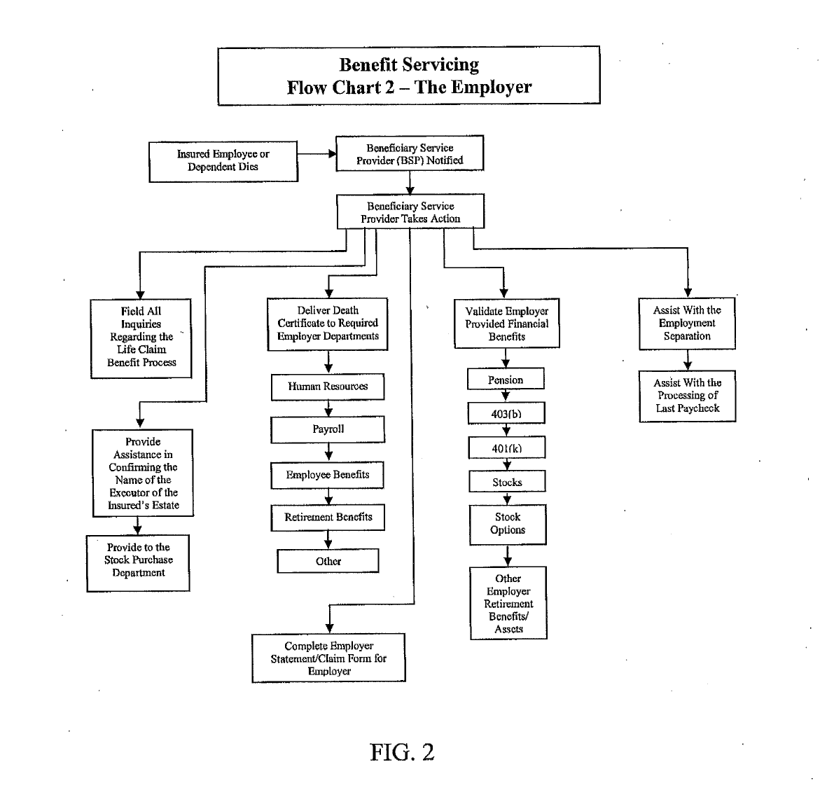

In addition to assisting the beneficiary, the BSP also assists the employer at the time of death of a covered person. In a the method depicted in FIG. 2, once notified of the death of a covered person, the BSP fields all inquiries regarding the life and accident claim benefit process. Preferably, the inquiries regarding the life and accident claim benefit process are handled, or coordinated, at a central location to prevent duplicative or contradictory information transmissions. The BSP also assists the employer with filling out and filing the employer statement and claim forms.

As described before, the BSP delivers a copy of the death certificate to the employer's internal departments, points of contact or entities that require the document. There may be other employer internal entities needing a copy of the death certificate which are identified by the employer. These other internal entities will also receive a copy of the death certificate as part of this inventive method. The BSP works with the employer to identify, gather, consolidate, and validate all financial information relevant to the employee's retirement benefits, such as a pension, a 403(b) or 401(k) retirement benefits, stock and stock purchase programs, or other retirement benefits. Using the information gathered with the employer, the BSP provides additional and expanded information to the beneficiary outlining the insurance proceeds, retirement benefits or account balances, and any stock account information.

When an employee dies, the employer must go through the process of terminating and separating the employee from the company. In addition to delivering the death certificate to the employer's departments described above, the BSP also assists with the processing of the last paycheck for the deceased employee.

As part of the preferred method, the BSP assists the stock purchase department, group or person within the employer's organization. Because any stock or stock option may be considered part of the estate of the covered person and is time sensitive, it is critical for the employer to know the executor of the estate to ensure they have knowledge of the stocks or stock options. The BSP provides assistance in identifying and/or confirming the name of the executor of the covered person's estate and delivering that information to the stock purchase department.

### Financial

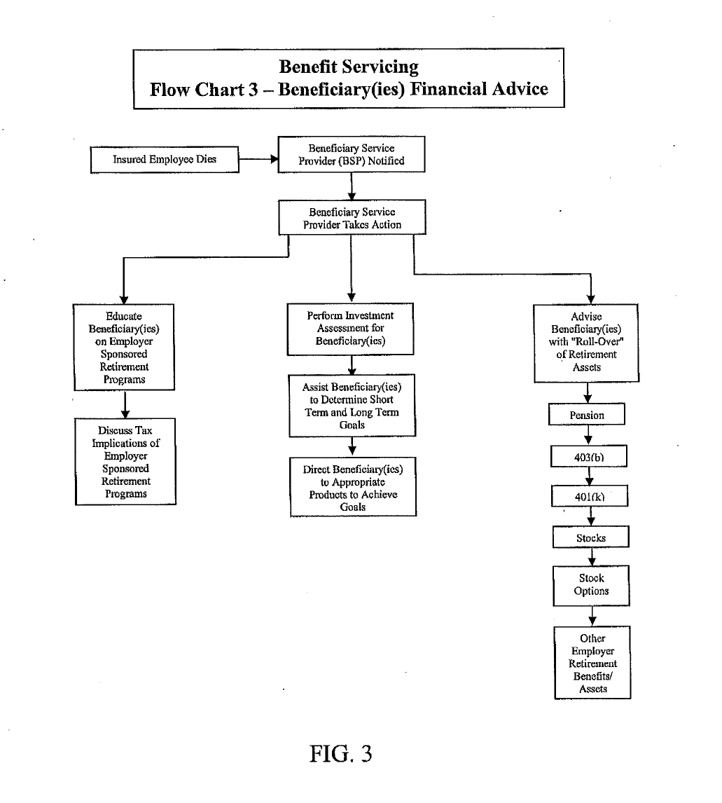

Referring to FIG. 3, in this embodiment of the method, the BSP provides education to the beneficiary on relevant company sponsored retirement programs. The BSP's letter to the beneficiary outlining and explaining a summary of the employer's retirement benefits program available to the beneficiaries provides existing information. The BSP also provides direct assistance to the beneficiary in understanding the tax implications of an asset disbursement from the employer by using letters, personal contact, telephone support, etc.

Additionally, the BSP offers to provide the beneficiary with an optional investment assessment and analysis to help them determine the best investment strategy and action plan for their situation. If the beneficiary accepts the optional analysis, the BSP's assessment analysis will help the beneficiary develop both short-term and long-term financial goals, and then direct the beneficiary to the appropriate products or financial advisors that will meet those goals.

The BSP also provides the beneficiary guidance regarding the “roll-over” of retirement assets in an employer's retirement programs to include pension plans, 401(k) retirement plans, 403(b) retirement plans, survivor benefits, and stock purchase plans.

### Dismemberment

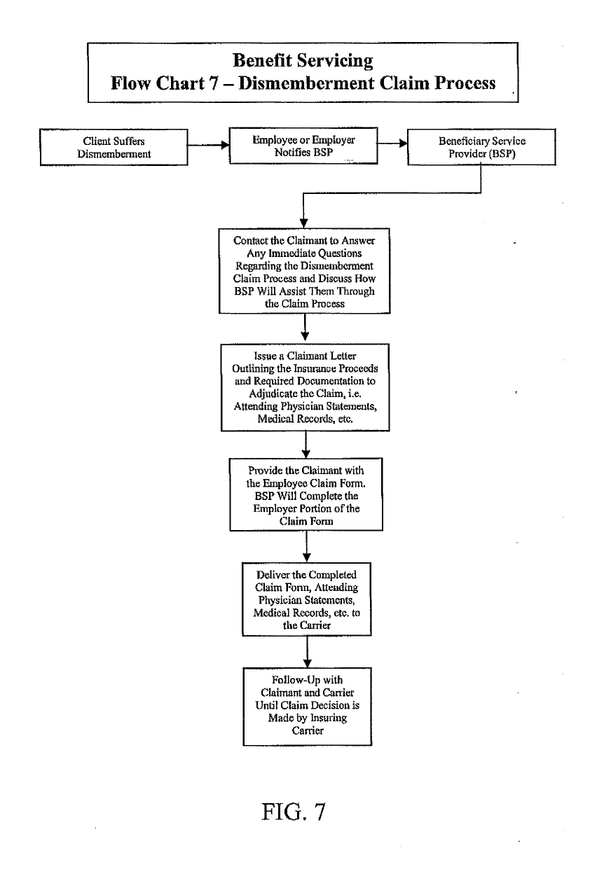

The BSP also assists the employer and covered person when a covered person suffers a dismemberment. Referring to FIGS. 1-4 and 7, the BSP helps the covered person obtain and track information related to their claims for dismemberment. The B SP will contact the claimant, which is the covered person, to answer any immediate questions regarding the dismemberment claim process. As part of the contact, the BSP will discuss the assistance provided to the claimant throughout the claim process. The BSP will issue a claimant letter outlining the insurance benefits and identify the required documentation to adjudicate the claim, i.e. attending physician statements, medical records, etc. The BSP will provide the claimant with the employee claim form. The BSP will complete the employer portion of the claim form. The BSP will deliver the completed claim form, attending physician statements, medical records, etc. to the insurance carrier for processing. Finally, the BSP will maintain contact with the claimant and carrier to provide status of the claim. The BSP will continue to follow-up with claimant and insurance carrier until a claim decision is made by insuring carrier. All approved claim decisions for dismemberment are processed in the same way as the life and accident benefits described above, and in FIGS. 1-4.

### Online Support

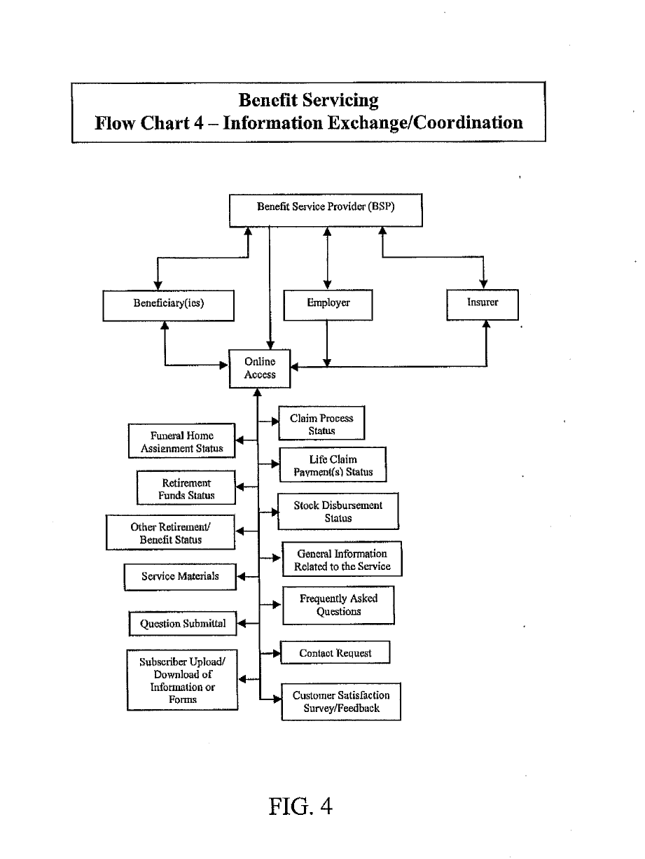

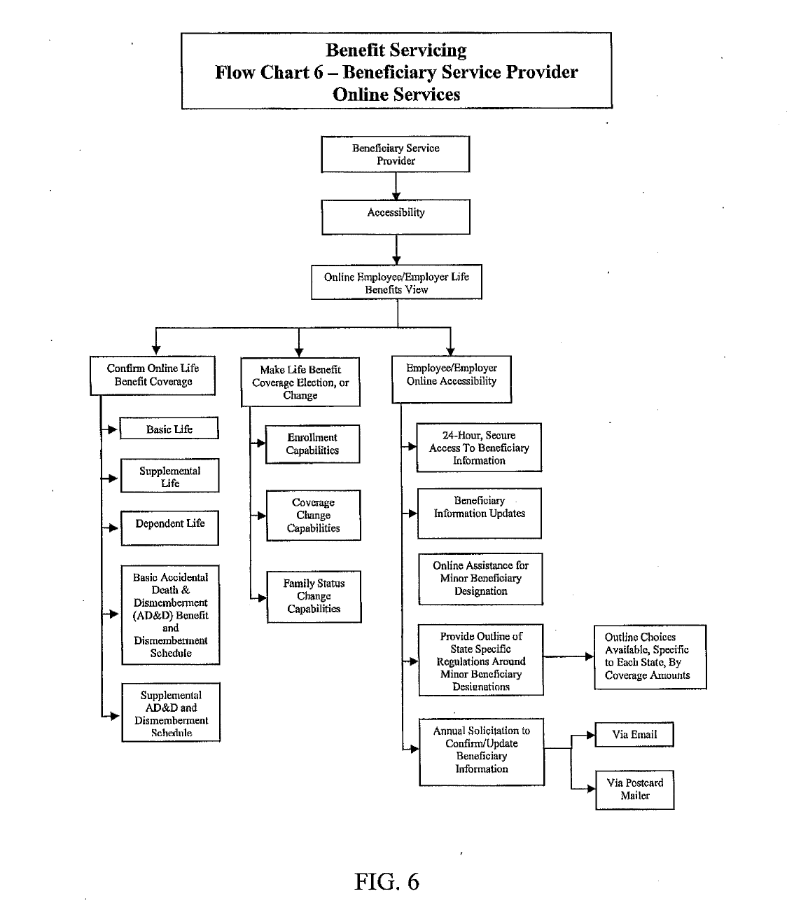

FIGS. 4 and 6 depict the BSP's online information exchange system server and process. In the preferred method, the BSP researches, acquires, consolidates, analyzes, electronically links and/or enters information into a central storage facility. The information may include status information regarding the claim processing, payments, guidance, and other information discussed above that the beneficiary, employer or insurer wants or needs. The BSP manipulates, collates, and sorts this information into accessible information for each individual covered person or beneficiary. The beneficiary accesses this information via a computer with internet (online) access. Additionally, the online information server hosts other common information such as a frequently asked question database, access to a concierge service provider, uploading of information, downloading of forms and guides, and other similar information. The information flows bi-directionally between the BSP, the beneficiary, the employer, and/or the insurer.

Referring to FIG. 6, the BSP provides online services. The online services allow both the covered person and the employer 24-hour access to all of their information. This access allows the operator, the covered person or employer, to make changes or updates to the beneficiary information at any time. An online assistance function is provided for minor beneficiary designations. The online system provides the operator with an outline of state specific regulations related to minor beneficiary designations. This includes which choices are available, specific information related to each state, and sorted by coverage amounts. The online system also allows the BSP to annually solicit confirmation or updates to the beneficiary information. This may be done via email or postcard mailers.

Using the online system allows the beneficiary to confirm the life and accident benefit coverage. This includes basic life, supplemental life, dependent life, basic accidental death and dismemberment (AD&D) and supplemental AD&D benefits, including the AD&D benefit schedules.

The online service also allows the beneficiary to update or make changes to the life and accident benefits. This includes coverage election, beneficiary information, or other status related information.

Thus, it is seen that the system and methods of the present invention readily achieve the ends and advantages mentioned, as well as those inherent therein. While certain preferred embodiments of the invention have been illustrated and described for purposes of the present disclosure, numerous changes in the arrangement and construction of parts and steps may be made by those skilled in the art. All such changes are encompassed within the scope and spirit of the present invention as defined by the appended claims.

What is claimed is:

1. A method for providing beneficiary services for an employer comprising the steps of:
identifying all employment benefits and benefit related information provided by the employer for a covered person, the benefit related information including identification of a beneficiary, an insurer, and at least one data set associating the beneficiary with the covered person;
entering information on the benefits and benefit related information into a computer database;
using the computer to analyze the information on the benefits and benefit related information provided by the employer;
correlating the beneficiary with the covered person and the benefits;
creating an event file in the database, the event file created when the covered person dies or suffers a dismemberment; and
said computer using said database to generate at least one beneficiary letter.

2. The method of claim 1, wherein said computer further generates status reports using data found in said database.

3. A method for providing beneficiary services for an employer comprising the steps of:
identifying all employment benefits and benefit related information provided by the employer for a covered person, the benefit related information including identification of a beneficiary, an insurer, and at least one data set associating the beneficiary with the covered person;
generating a database of benefits and befit related information;
analyzing the information on the benefits and benefit related information provided by the employer;
correlating the beneficiary with the covered person and the benefits;
creating an event file in the database, the event file created when the covered person dies or suffers a dismemberment; and
generating at least one beneficiary letter.
